(19) United States
(12) Patent Application Publication
(10) Pub. No.: US 2013/0173322 A1
(43) Pub. Date: Jul. 4, 2013

(54) Energy Management with Correspondence Based Data Auditing Signoff

(71) Applicant: Anthony R. Gray, Victoria (CA)

(72) Inventor: Anthony R. Gray, Victoria (CA)

(73) Assignee: SCHNEIDER ELECTRIC USA, INC., Palatine, IL (US)

(21) Appl. No.: 13/341,394

(22) Filed: Dec. 30, 2011

(51) Int. Cl. G06Q 10/06

(52) U.S. Cl. 705/7.13

(57) ABSTRACT

Systems and methods for monitoring energy management (EM) data from at least one energy data source; detecting a data anomaly event in the EM data; determining if a resolution for the data anomaly event requires human input; and submitting a request to at least one user for human input to resolve the data anomaly event.

### BACKGROUND

1. Technical Field

Embodiments of the present invention relate generally to energy management and, more particularly, some embodiment relate to energy management systems and methods that provide for improved classification of anomalous data.

2. Background Information

Energy management (“EM”) systems are delivering the information and control capabilities businesses need to effectively lower energy costs and increase productivity by avoiding power-related disruptions. However, the quality of energy decisions is directly affected by the quality of the data on which these decisions are based.

### SUMMARY

Various embodiments of the present invention provide methods and systems comprising monitoring energy management (EM) data from at least one energy data source, detecting a data anomaly event in the EM data, determining if a resolution for the data anomaly event requires human input, submitting an automated request to at least one user for human input to resolve the data anomaly event, and recording a record of the request in a database for a resolution response from the at least one user. The at least one request to at least one user may be communicated via one or more correspondence media, such as email, an SMS message, voicemail, instant messaging, and/or a posting to social media platform.

Additionally, some embodiments of the present invention provide methods and systems comprising monitoring energy management (EM) data from a plurality of energy data sources, detecting a plurality of data anomaly events in the EM data, analyzing the data from the plurality of energy data sources to determine if the data anomaly events meet at least one correlation criterion, and if the data anomaly events meet the correlation criterion, then processing the data in accordance with the correlation criterion to resolve the data anomaly events.

Systems according to some embodiments may comprise at least one computer, at least one storage device in which is stored EM data, and at least one non transitory computer readable medium storing thereon computer code which when executed by the at least one computer causes the at least one computer to be operable in executing a method according to one or more of the embodiments summarized above.

Some embodiments provide at least one non transitory computer readable medium that stores programming code that when executed by at least one computer, instructs the at least one computer to execute a method according to one or more of the embodiments summarized above.

Throughout the specification and claims, the following terms take at least the meanings explicitly associated herein, unless the context dictates otherwise. The meanings identified below do not necessarily limit the terms, but merely provide illustrative examples for the terms. The phrase “an embodiment” as used herein does not necessarily refer to the same embodiment, though it may. In addition, the meaning of “a,” “an,” and “the” include plural references; thus, for example, “an embodiment” is not limited to a single embodiment but refers to one or more embodiments. Similarly, the phrase “one embodiment” does not necessarily refer the same embodiment and is not limited to a single embodiment. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise.

It will be appreciated by those skilled in the art that the foregoing brief description and the following detailed description are exemplary (i.e., illustrative) and explanatory of the present invention, but are not intended to be restrictive thereof or limiting of the advantages which can be achieved by this invention in various implementations. Additionally, it is understood that the foregoing summary and ensuing detailed description are representative of some embodiments of the invention, and are neither representative nor inclusive of all subject matter and embodiments within the scope of the present invention. Thus, the accompanying drawings, referred to herein and constituting a part hereof, illustrate embodiments of this invention, and, together with the detailed description, serve to explain principles of embodiments of the invention.

### BRIEF DESCRIPTION OF DRAWINGS

Aspects, features, and advantages of some embodiments of the invention, both as to structure and operation, will be understood and will become more readily apparent when the invention is considered in the light of the following description made in conjunction with the accompanying drawings, in which like reference numerals designate the same or similar parts throughout the various figures, and wherein:

FIGS. 1A and 1B illustrate exemplary high level Enterprise Energy Management components and network architectures;

FIG. 2 illustrates an exemplary structure of a server, system, or a terminal according to an embodiment;

FIG. 3 illustrates an exemplary high level flow and architecture for data cleansing and validation; and

FIGS. 4A and 4B illustrates exemplary high level flows for submitting data anomaly events for human analysis.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. Embodiments of the present invention are disclosed or are apparent from and encompassed by, the following description.

A large EM system such as an Enterprise Energy Management (“EEM”) system typically comprises a network of web-enabled software and intelligent metering and control devices, as well as other inputs. (The terms EM system and EEM system are used interchangeably throughout this disclosure.) A system can track all forms of utilities consumed or generated, including electricity and gas, as well as water, compressed air and steam. Data can be gathered from the utility billing meters or other meters positioned at each service entrance, from tenant or departmental sub-meters, and from instruments that are monitoring the conditions of equipment such as generators, transformers, breakers, and power quality mitigation equipment. Other inputs can include weather information, real-time pricing information, occupancy rates, emissions data, consumption and condition data from building automation systems, production data from enterprise resource planning (ERP) systems, and other energy-related data.

In large energy management EM systems that collect data for many facilities, there is a range in the quality of data for energy consumption data. As such, the energy consumption data can present problems for EM. Examples of such data problems include but are not limited to: missing data, impossibly large or small values, and delayed data arrival. EM systems can be configured to automatically (e.g., without human intervention or manual input) monitor for common data problems in incoming measurement data so as to meet standards for reporting output. When data problems are detected, the EM system is faced with the choice of either reporting on problems, or acting automatically to correct them. The challenge for automatic detection and correction is that the classification of data as either legitimate or suspect can require information only available at the site where data came from. For example, an isolated spike in measured energy consumption might represent bad data, or the spike might represent legitimate data from a highly variable load. As another example, a string of missing values could represent a communication problem from an energy monitoring device (e.g., an IED, as discussed below), or may represent a legitimate electrical service interruption during plant maintenance.

In diagnosing whether data is reporting a legitimate energy management issue or is a false data signal, a number of problems occur. For example, in a large EM system, if human judgment is required to diagnose the data, there may be no operator available when and where the potential error is detected with whom to confirm if the data reporting is accurate. As another example, in a geographically expansive multi-national system, the person with the necessary context to resolve an ambiguity in the data may be in a different time zone and/or speak a different language than an operator of the EM system.

The conventional response to this problem has been to either (1) ignore data problems and not attempt to solve them, or to (2) encode sophisticated logic in the EM system to attempt to infer the classification of data anomalies and the desired action to take in response to them. Both approaches run the risk of degrading data integrity; the first by allowing corrupted data into the reporting system, and the second by taking possibly incorrect remedial action (e.g., based on an incorrect classification inference).

Disclosed are embodiments of systems and methods to solicit resolution information from a person with localized knowledge needed to resolve a data audit problem. In various embodiments, persons with localized knowledge are contacted when the person is not readily available or may not have any direct access to the EM system. As will be further understood from the ensuing disclosure, some embodiments of the EM system may automatically identify which data requires human input to resolve, and for such identified data the EM system may automatically invoke a communication to one or more persons who may have localized knowledge for resolving the data audit problem. Additionally, in various embodiments, the EM system may automatically process responsive communications from the one or more persons and further automatically resolve the data audit problem based on the responsive communication(s).

Unlike conventional methods of user interaction, as disclosed herein a computer system and a person with whom interaction is desired may be physically and temporally separated, so the interaction takes place over a medium that can support delayed responses, differing languages, and long distance communication. In various embodiments, therefore, the EM system may automatically invoke communications to each such person over one or more communication media or systems that are out-of-band with respect to the EM system, and the EM system may also automatically receive responsive communications transmitted by the person via the one or more out-of-band communications media or systems. Thus, for example, if the person does not have access to the EM system (e.g., because the person is separated therefrom), the person may nonetheless receive data audit communications from the EM system and the EM system may receive responses from the person.

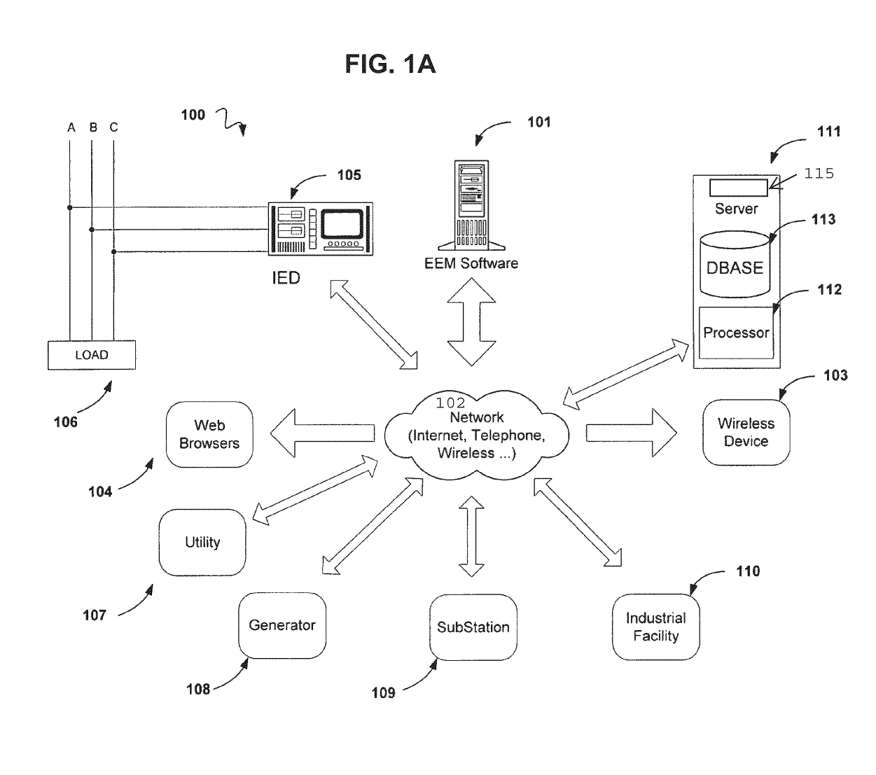

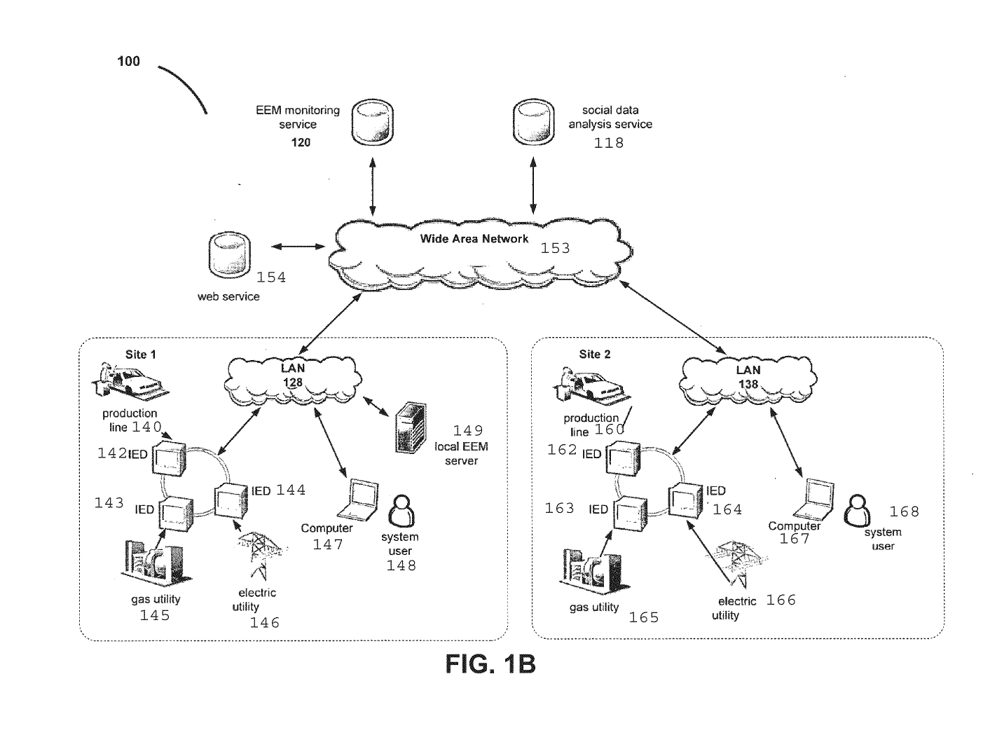

Referring to FIG. 1A, some disclosed embodiments relate to an illustrative EM software system 100, described herein as an EEM software system 100, that may collect data from various types of EEM data sources and create useful information based on that data. The EEM software system 100 may also allow a user to perform what-if analysis, make changes in their system, and verify results based on the changes. As illustrated, the EEM software system 100 may include an EEM software server 101 that may be coupled with a network 102. As used herein, the network 102 should be broadly construed to include any one or more of a number of types of networks that may be created between devices using an Internet connection, a LAN/WAN connection, a telephone connection, a wireless connection, and so forth.

Each of the terminals, servers, and systems may be, for example, a server computer or a client computer or client device operatively connected to network 102, via bi-directional communication channel, or interconnector, respectively, which may be for example a serial bus such as IEEE 1394, or other wire or wireless transmission medium. The terms “coupled with,” “operatively connected,” “operatively coupled,” and “communicatively coupled”, as used herein, mean that the elements so connected or coupled are adapted to transmit and/or receive data, or otherwise communicate. This connection/coupling may or may not involve additional transmission media, or components, and may be within a single module or device or between the remote modules or devices. The terms “connected” and “coupled” thus include directly connected to or indirectly connected through one or more intermediate components. Such intermediate components may include both hardware and software based components.

The terminals, servers, devices, and systems are adapted to transmit data to, and receive data from, each other via the network 102. The terminals, servers, and systems typically utilize a network service provider, such as an Internet Service Provider (ISP) or Application Service Provider (ASP) (ISP and ASP are not shown) to access resources of the network 102.

Although each of the above described terminal, server, and system may comprise a full-sized personal computer, the system and method may also be used in connection with mobile devices capable of wirelessly exchanging data with a server over a network such as the Internet. For example, a terminal, client device or user device may be a wireless-enabled PDA such as an iPhone, an Android enabled smart phone, a Blackberry phone, or another Internet-capable cellular phone.

It should be appreciated that a typical system can include a large number of connected computers (e.g., including server clusters), with each different computer potentially being at a different node of the network 102. The network, and intervening nodes, may comprise various configurations and protocols including the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computers, such as modems (e.g., dial-up, cable or fiber optic) and wireless interfaces.

A plurality of Intelligent Electronic Devices (“IEDs”) 105 may be coupled with the EEM software server 101. The IEDs 105 may be coupled with a load 106, which the IEDs 105 are responsible for monitoring and reporting various types of energy data related to the load 106. IEDs 105 may include revenue electric watt-hour meters, protection relays, programmable logic controllers, remote terminal units, fault recorders and other devices used to monitor and/or control electrical power distribution and consumption. IEDs 105 are widely available that make use of memory and microprocessors to provide increased versatility and additional functionality. Such functionality includes the ability to communicate with other hosts and remote computing systems through some form of communication channel. IEDs 105 also include legacy mechanical or electromechanical devices that have been retrofitted with appropriate hardware and/or software allowing integration with the EEM system.

An IED 105 may be associated with a particular load or set of loads that are drawing electrical power from the power distribution system. The IED 105 may also be capable of receiving data from or controlling its associated load. Depending on the type of IED 105 and the type of load it may be associated with, the IED 105 may implement a energy management function that is able to respond to, implement and/or generate further management functions, measure energy consumption, control energy distribution such as a relay function, monitor power quality, measure energy parameters such as phasor components, voltage or current, control energy generation facilities, compute revenue, control electrical power flow and load shedding, or combinations thereof. For functions which produce data or other results, the IED 105 may push the data onto the network 102 to another IED 105, data output device or back end server/database, automatically or event driven, or the IED 105 can wait for a polling communication which requests that the data be transmitted to the requestor.

For the purposes of the disclosed illustrative embodiments, a computer or computing device may be broadly defined as a device which comprises a processing unit and includes, but is not limited to, personal computers, terminals, network appliances, Personal Digital Assistants (“PDAs”), IEDs, wired and wireless devices, tablet personal computers, game boxes, mainframes, as well as combinations thereof as are presently available or later developed.

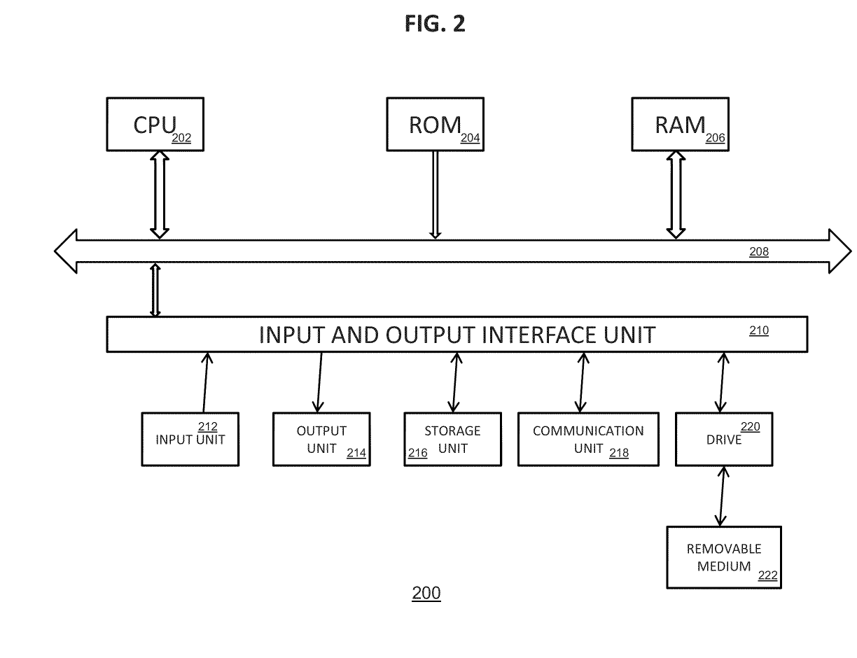

FIG. 2 illustrates an exemplary structure of a server, system, or a terminal according to an embodiment. The exemplary server, system, or terminal 200 includes a CPU 202, a ROM 204, a RAM 206, a bus 208, an input/output interface 210, an input unit 212, an output unit 214, a storage unit 216, a communication unit 218, and a drive 220. The CPU 202, the ROM 204, and the RAM 206 are interconnected to one another via the bus 208, and the input/output interface 210 is also connected to the bus 208. In addition to the bus 208, the input unit 212, the output unit 214, the storage unit 216, the communication unit 218, and the drive 220 are connected to the input/output interface 210.

The CPU 202, such as an Intel Core™ or Xeon™ series microprocessor or a Freescale™ PowerPC™ microprocessor, executes various kinds of processing in accordance with a program stored in the ROM 204 or in accordance with a program loaded into the RAM 206 from the storage unit 216 via the input/output interface 210 and the bus 208. The ROM 204 has stored therein a program to be executed by the CPU 202. The RAM 206 stores as appropriate a program to be executed by the CPU 202, and data necessary for the CPU 202 to execute various kinds of processing.

A program may include any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The input unit 212 includes a keyboard, a mouse, a microphone, a touch screen, and the like. When the input unit 212 is operated by the user, the input unit 212 supplies an input signal based on the operation to the CPU 202 via the input/output interface 210 and the bus 208. The output unit 214 includes a display, such as an LCD, or a touch screen or a speaker, and the like. The storage unit 216 includes a hard disk, a flash memory, and the like, and stores a program executed by the CPU 202, data transmitted to the terminal 200 via a network, and the like.

The communication unit 218 includes a modem, a terminal adaptor, and other communication interfaces, and performs a communication process via the network(s) described herein.

A removable medium 222 formed of a magnetic disk, an optical disc, a magneto-optical disc, flash or EEPROM, SDSC (standard-capacity) card (SD card), or a semiconductor memory is loaded as appropriate into the drive 220. The drive 220 reads data recorded on the removable medium 222 or records predetermined data on the removable medium 222.

One skilled in the art will recognize that, although the data storage unit 216, ROM 204, RAM 206 are depicted as different units, they can be parts of the same unit or units, and that the functions of one can be shared in whole or in part by the other, e.g., as RAM disks, virtual memory, etc. It will also be appreciated that any particular computer may have multiple components of a given type, e.g., CPU 202, Input unit 212, communications unit 218, etc.

An operating system such as Microsoft Windows 7®, Windows XP® or Vista™, Linux®, Mac OS®, or Unix® may be used by the terminal. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

Data may be retrieved, stored or modified in accordance with the instructions. For instance, although the system and method is not limited by any particular data structure, the data may be stored in computer registers, in a relational database as a table having a plurality of different fields and records, XML documents, flat files, etc. The data may also be formatted in any computer-readable format such as, but not limited to, binary values, ASCII or Unicode. The textual data might also be compressed, encrypted, or both. By further way of example only, image data may be stored as bitmaps comprised of pixels that are stored in compressed or uncompressed, or lossless or lossy formats (e.g., JPEG), vector-based formats (e.g., SVG) or computer instructions for drawing graphics. Moreover, the data may comprise any information sufficient to identify the relevant information, such as numbers, descriptive text, proprietary codes, pointers, references to data stored in other memories (including other network locations) or information that is used by a function to calculate the relevant data.

It will be understood by those of ordinary skill in the art that the processor and memory may actually comprise multiple processors and memories that may or may not be stored within the same physical housing. For example, some of the instructions and data may be stored on removable memory such as a magneto-optical disk or SD card and others within a read-only computer chip. Some or all of the instructions and data may be stored in a location physically remote from, yet still accessible by, the processor. Similarly, the processor may actually comprise a collection of processors which may or may not operate in parallel. As will be recognized by those skilled in the relevant art, the terms “system,” “terminal,” and “server” are used herein to describe a computer's function in a particular context. A terminal may, for example, be a computer that one or more users work with directly, e.g., through a keyboard and monitor directly coupled to the computer system. Terminals may also include a smart phone device, a personal digital assistant (PDA), thin client, or any electronic device that is able to connect to the network and has some software and computing capabilities such that it can interact with the system. A computer system or terminal that requests a service through a network is often referred to as a client, and a computer system or terminal that provides a service is often referred to as a server. A server may provide contents, content sharing, social networking, storage, search, or data mining services to another computer system or terminal. However, any particular computing device may be indistinguishable in its hardware, configuration, operating system, and/or other software from a client, server, or both. The terms “client” and “server” may describe programs and running processes instead of or in addition to their application to computer systems described above. Generally, a (software) client may consume information and/or computational services provided by a (software) server.

Returning to FIG. 1A, the EEM software server 101 may be coupled with a utility 107, a generator 108, a substation 109, and an industrial facility 110 and so forth. The entities 107-110 may record and report various types of EEM data that is sent to the EEM software server 101 as set forth in greater detail below. In addition, as used herein, the entities 107-110 should be construed to include various types of computer workstations located at these types of facilities that may connect with and use the EEM software application that is located on the EEM software server 101. As such, as referred to herein, the devices 107-110 should be construed broadly to include various different types of computing devices that may transfer various types of energy consumption data to the EEM software server 101, as well as access the EEM software server 101 to use the EEM software application located thereon.

The EEM software server 101 may be coupled with one or more wireless devices 103. The wireless devices 103 may be IEDs, cellular telephones, or any other device that is capable of communicating wirelessly. The wireless devices 103 may transmit data to and/or receive data from EEM software server 101.

The EEM software server 101 may be coupled with one or more web browsers 104. The web browsers 104 may run on any computing device, and may access an EEM software application located on the EEM software server 101.

As illustrated in FIG. 1A, the EEM software server 101 may be coupled with a database server 111. The database server 111 may include a processor 112 that is programmed to interpret and process incoming data from any of the devices or entities that are coupled with the EEM software system 100. The database server 111 may include a database 113 that is designed to store various types of data that may be used by the EEM software system 100. The various types of devices or entities that are coupled with the EEM software system 100 may be designed to transfer EEM data to the database server 111, which may then be retrieved and used by the EEM software system 100. As such, as used herein, the database server 111 should be construed broadly as any type of device that is designed to receive, validate, and store data that may be used and accessed by the EEM software application, and as such may be part of EEM software server 101, or may be located on a separate device 111. The database server is operatively coupled to a data quality tool 115 (e.g., implemented as a software system or module) which is designed to cleanse data and the database server 111 is further configured to generate electronic correspondence to request input from users on data anomaly events, as described herein.

In some of the disclosed embodiments, EEM system components may share EEM data with one another. While one illustrative embodiment of the EEM software system 100 is depicted in FIG. 1A, it can be appreciated that an EEM system can be scaled out to include additional external data sources, or scaled down to include only internal data sources, such as only communications or data within a geographic location or area. It can also be appreciated that an EEM software system can accept data from local EEM software systems, such as in EEM monitoring service 120 that accepts data from a local EEM server. For example, FIG. 1B illustrates a high level view of an exemplary system architecture 150, according to one embodiment, as described in U.S. patent application Ser. No. 11/899,809 (published as U.S. Patent Publication No. 2009/0070168) entitled Enterprise Energy Management System with Social Network Approach to Data Analysis, the entirety of which is hereby incorporated by reference. The architecture 150 includes an enterprise energy management service 120, a social data analysis service 118, data source 104, and at least two local area networks 128, 138, denoted in the figure as “site 1,” and “site 2,” coupled together via a wide area network 153.

Enterprise energy management monitoring service 120, social data analysis service 118, local EEM server 149, and user devices 148 and 168 may represent various types of computing devices. These devices may generally include any device that is capable of performing computations and sending and/or receiving data over a network as described herein. The wide area network 153 and/or local area networks 128, 138 may include the Internet, a public or private intranet, an extranet, or any other network configuration to enable transfer of data and commands including wired and or wireless networks, or combinations thereof, as described herein.

As described herein, EEM data may include, but is not limited to, electrical operation data such as volts, amps, status, power; power quality data such as harmonics, power factor, reliability (such as number of nines), disturbance data; consumption data such as energy and demand; event data such as set point actions, status changes and error messages; financial data such as energy cost, power factor penalties, revenue data, billing data such as tariffs for water, air, gas, electricity and steam; environmental data such as temperature, pressure, humidity and lightning/atmospheric disturbance data; water-air-gas-electric-steam (“WAGES”) data; configuration data such as frameworks, firmware, software, calculations involving EEM data and commands; and aggregated data, where at least one energy management datum is combined with other data points. For the purposes of this application, combined data may include aggregated data and computed data.

The data sources in FIGS. 1A and 1B 104-110, 140-146, 160-164, and 160-166 may represent some of the possible sources of data that can be included in the data analysis. For example, as shown in FIG. 1B, the IED's 143 and 163 may collect energy related data associated with a gas utility 145 in Site 1 and Site 2 respectively. The IED's 144 and 164 may collect energy related data associated with an electric utility 166, and the IED's 142 and 162 may collect energy related data associated with a process control system such as a production line, each in Site 1 and Site 2 respectively. The data source 154 may represent additional data sources (e.g. web services) that offer EM attribute data including data relevant to the analysis of energy use. One example of such relevant data might be the hourly ambient temperature readings offered by a weather service company. Other examples include financial market data, local news data, national news data, and world news data. Other data sources not listed above may also be included in addition to those already stated. Site 1 and Site 2 represent two of the many possible configurations that may be used in a given site. System users 148 and 168 may represent possible members of the social network described herein. For example, system user 148 may be a building manager for building A while user 168 may be a building manager for building B. System users 148 and 168 may be unaffiliated with each other. In an alternative embodiment, the users of the architecture 100 may be limited to users of a particular organization or entity. The configurations of sites 1 and 2 are only exemplary and should not be used to limit this disclosure.

The EEM monitoring service 120 may collect energy related data from several IED's within several unrelated and/or unaffiliated sites. The EEM monitoring service 120 may also collect data from other sources that may have an impact on power or power quality. For example, the EEM monitoring service 120 may collect power related data from an online weather service. The EEM monitoring service 120 may store the power related data received by each IED and categorize the data according to various attributes.

Site 1 illustrates a common logical architecture for an enterprise energy management monitoring system at a typical installation, which may be physically located across one or more geographic regions. Several intelligent electronic devices (IEDs) 142, 143, 144 may be attached at various points of one or more energy distribution networks such as electric, gas, steam, etc. (not shown). At site 1, the IED's 142, 143, 144 may each monitor energy related devices at different points within a local area network 128. For example, as noted above the IED 144 may represent a monitoring device for the gas utility 145, the IED 146 may represent a monitoring device for the electric utility 146 and the IED 142 may represent a monitoring device for a production line 140, such as a device which monitors the energy consumption of the machines which make up the production line. A local EEM server 149 may collect data from at least one of the data sources 154, 145, 146, and 140 via the IED's 142-144. The IED's 142-144 may push the data to the EEM server 149 or the EEM server 149 may periodically poll the data sources for updates, or a combination of both. In one embodiment, the EEM server 149 polls the IED's 142-144 at various intervals and collects energy related data gathered by each IED. The EEM server 149 validates and processes the data and presents the data to one or more users at the site such as system user 148. A system user 148 may view the data provided by EEM server 114 using laptop computer 147 or other device (not shown). As described herein, the EEM server 149 or data monitoring service 120, which may be coupled to or include a database server (not shown), is also configured to send correspondence to a user for resolution of data anomalies as described herein.

Site 2 includes data sources 160, 165 and 166; IED's 162-164; laptop computer 167, and system user 168. At site 2, the IED's 162-164, and a computer 167 may be connected through the local area network 138. Site 2 may include an alternate configuration of IED's. The IED's 162-164 may collect similar energy related data as IED's 142-144 in site 1 or they may be collecting energy related data from other sources. The laptop computer 167 may include a web based application for monitoring the IED's 162-164 of Site 2. More specifically, instead of having an EEM server 149 as is provided at site 1, at site 2, the user subscribes to an EEM service 120 that acquires data from the site, archives it and offers the data back to the user as a service. Thus, at site 2, the IED's 162-164 send their associated energy related data directly through a central online EEM service 120 provided by an electric utility entity or an online service provider which archives, process and presents this data to one or more site 2 users. Thus, a system user 168 can view energy related data or access associated with site 2 through an online software tool. In such an embodiment, the EEM server data monitoring service 120 or an external EEM server (not shown) may be coupled to or may include a database server (not shown) and is also configured to send correspondence to a user for resolution of data anomalies as described herein.

The Database EEM server 101 is configured to validate and or correct data that is anomalous using data quality tools configured for validation, editing and estimation (“VEE”). Data quality can be considered in terms of three main categories of criteria:

(1) Validity. Not only does data need to be present as required (e.g., typically required for every measurement made by every IED or other metering device), the data values and timestamps need to be scrutinized in terms of whether they are reasonable compared to established patterns. The data must be within the allowable range expected for that parameter. For example, if a monthly total energy value is being viewed for a facility, there will be a maximum to minimum range that one would be expected the usage to fall within, even under the most extreme conditions. If a value is “out of bounds”, it probably indicates an error in the measurement, storage, transmission, reception or manipulation of the measured value on its way to the EEM monitoring service 120.

(2) Accuracy. The data gathered and stored needs to be true to what is being represented, with a high enough accuracy to base effective decisions on. This not only requires that external input to the system is considered in terms of its accuracy, including third-party data feeds. For enterprise-wide systems, it is also important that the time at which each measurement is taken be accurately recorded. When an aggregate load profile is being developed for multiple facilities across geographically dispersed locations, the measurements need to be tightly time-aligned. This is also true for sequence-of-events data being used to trace the propagation of a power disturbance.

(3) Completeness. For any EEM system, incomplete data can seriously compromise the precision of trends and projections. There needs to be a complete data set; each recorded channel of information must contain all the records and fields of data necessary for the EM needs of that information. For example, if interval energy data is being read from a tenant sub-meter, there can be no empty records. Such gaps might be mistakenly interpreted as zero usage, and in turn the tenant could be under-billed for energy that month.

In EEM systems, the above types of data quality issues can come from a number of sources, and for a number of reasons. For example, data that is out of range might be the result of an energy meter being improperly configured when it was installed, or a meter that has been improperly wired to the circuit it is measuring. There may also be inconsistencies between how a number of meters on similar circuits are configured, or differences between how the meters and the head-end software are set up.

Another source might be the “rollover” characteristic of registers inside most energy meters. Most energy meters have a specific maximum energy value they can reach, for example 999,999,999 kilowatt-hours. The registers will then rollover and start incrementing again from a count of zero (000,000,000). A system reading the information from the meter may not recognize this behavior and instead interpret values as being in error, or worse, interpret it as a negative value which produces large errors in subsequent calculations.

When there are gaps in data records, the source might be a loss of communications with a remote meter or other device or system due to electrical interference, cable integrity, a power outage, equipment damage or other reasons. Some communication methods are inherently less reliable than others; for example, a dial-up modem connection over a public telephone network will likely be less reliable than a permanently hardwired Ethernet connection. Some meters offer onboard data logging that allows saved data to be uploaded after a connection has been restored, reducing the possibility of gaps. But an extended communication loss can still cause problems.

Other breaks in communication can include the interruption of an Internet connection over which weather or utility rate information is being imported, or the failure of the network feeding information from a third-party building or process automation system. As additional diverse sources of real-time and historical information are integrated into an EEM system the possibility of communications problems increases.

A remote meter, sensor, or other instrument may also simply fail to operate properly, or fail to operate at all, causing a continuous interruption in data flow until the device is repaired or replaced. Finally, in cases where some remote meters are not permanently connected by a communications link, their data might be collected manually with a dedicated meter reading device or laptop computer, and then manually entered into the head-end system. Anytime this kind of human intervention is required there is room for error.

Data quality tools 115 take into account the wide range of input types that EEM systems leverage to develop a complete understanding of energy usage across an enterprise. To validate that data is of high quality, EM systems 100, EM software servers 101, and/or database servers 111 are configured with data quality tools 115 including set of internal standards that define the level of data quality required for each purpose. For example, a property manager may decide that data for sub-billing is acceptable with lower quality than the data used for utility bill verification. Based on the quality standards, the data quality tool is configured with a set of rules constructed to automatically check the quality of energy-related data coming into the EEM system 100. Examples of these rules include the following:
Constraints checks. As mentioned earlier, incoming data representing a particular parameter must meet a bounds check to see if it falls within a reasonable expected domain of values, such as a minimum-to-maximum range. Those that fall outside predefined constraints are flagged as “out of bounds”. In the case of meter energy register rollovers, a delta check can be done to see if the previous and currently read values differ by too much to be reasonable. Similarly, checks can be run to verify data corresponds to a specific established set of allowable values. For example, a record indicating alarm status should either show an active or inactive state, possibly represented as a 1 or a 0. No other value is acceptable. (Note: Though not an error check, tests will also be run on some data to find which sub-range a measurement falls in within the acceptable boundaries of values. This is needed when the value of a measurement determines how it is used in subsequent calculations. For example, some utilities charge for energy by applying different tariff charges to different levels of energy demand measured over specific demand intervals (usually 15 minutes), or to energy consumed at different times of the day, week or year. If a recorded demand level is greater than or equal to “x demand”, a different tariff may be applied than if the value is less than “x demand”.
Duplicate check. The system will check for consecutive records having exactly the same data in them. This can include situations where both the value and the timestamp are the same for both records, or where the timestamps are the same but the values are different. Normally this will indicate an error due to a communication problem, improper system settings or metering logging configuration, time jitter, or other issue.
Completeness (gap) check. When verifying interval energy data, where records are expected at specific time intervals (e.g. every 15 minutes), gaps in data are flagged. These can be due to message transfer issues, power outages, communication issues, etc. Missing records can then be compensated for in a number of ways.
Dead source detection. If a gap in data is long enough the system can flag it as a dead source so that appropriate steps can be taken to investigate the cause.
Zero, null and negative detection. If an energy meter is showing “zero” energy usage for a particular facility, load or other metered location, when that condition is not expected, it will be flagged as a possible error. This can include either a zero reading for an individual interval, or a delta (difference) check between two consecutive readings of a totalizing register. It can then be investigated to see if there may have been a major ower outage event. If so, the error indication can be manually overridden. Null readings (e.g. a timestamped non-numeric value) can also indicate a problem. Finally, negative checks are done to ensure consecutive readings in a cumulative register are not decrementing instead of incrementing. This can catch conditions such as meter resets, register rollovers, and other issues for measurements of guaranteed monotonically increasing quantities.
Timestamp check. Measured values being aggregated together need to be accurately time-aligned. The data quality tools will verify if all timestamps for all values being summed are within an acceptable proximity of each other, often referred to as time jitter. Excessive jitter can sometimes be the result of delays caused by a gateway device or software polling a remote meter.
Other tests. Further tests can be applied to help determine if data input is reasonable. For example, a spike check (commonly done by utilities) will compare the relative variance between the first and third highest peak energy readings during a specific period—if they differ by more than a predefined acceptable amount it is flagged as a possible data error.

The EEM system 100 is configured to include data quality component 115 for ongoing monitoring for conditions in incoming EEM data which might require human judgment to identify and possibly correct. In an embodiment, the data quality component comprises an EEM monitor, embodied as a continuously operating software component configured for ongoing monitoring for conditions in incoming data which might require human judgment to identify and possibly correct. The EEM monitor is assumed to be operating continuously on a computer system in an unattended mode, i.e. without a user or human operator who can respond quickly to displayed messages or sounds at a computer console.

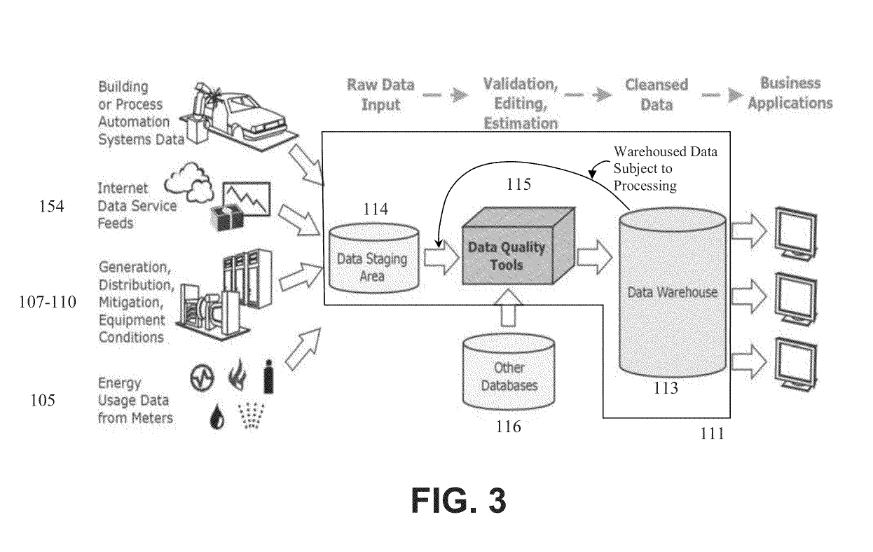

A data cleansing architecture and flow for the data validation according to some embodiments is described in FIG. 3. In one embodiment, the data cleansing process can be positioned at the point where collected data first enters the enterprise energy management system 100 for processing by the Data Quality Component 115 software, before it makes it through to a database 113 of the data server 111. In some embodiments, the database sever 111 may be configured to include a front-end data staging area 114. Data inputs as described herein input into the staging area 114 can already be parsed and translated into the proper units as necessary. The staging area 114 acts as the raw data input to the data quality process. Those skilled in the art will understand, however, that in some implementations, rather than using a separate staging area (the so-called “quarantine” approach), data that has been processed and validated may instead be marked or flagged, without being segregated in a staging area.

Although the system 100 is configured to pass data on through to the a data warehouse (or data mart) of the database 113 after the data is validated or corrected, the system can be configured to resolve identified data anomalies even after the data has passed to the database 113. For example, in some implementations, some long-term VEE activities that may require accumulation of weeks or months of data before they can be run. In those cases, the VEE tests that could be run on short term data have already been completed, and the longer time scale VEE tests would run on the previously tested data.

In an embodiment, a data quality tool 115 of the EEM system 100 monitors one or more streams of incoming EM data from one or more EM data sources 106-110 processed and stored in the database 113 for anomalous data conditions as determined in a configuration step by a system operator module. Known systems and methods for detecting and correcting anomalous data could be employed as are known to ordinarily skilled artisans. For example, in one embodiment after a data quality tool 115 has been used to verify the validity of incoming data, suspected errors will be flagged. The Data quality component 115 software then has a variety of options to choose from. Based on the defined data quality standards, the EEM software 101 can in some cases be configured to ignore a particular problem or anomaly for a data element, if it is not of high enough importance. For other data, the data quality tool 115 can be configured to correct or compensate for anomalies that are known to be errors.

For example, first, the data anomaly may comprise exact duplicates, which can be classified as known bad errors, and can be automatically deleted. Rules can also be configured to deal with near duplicates; the data quality component 115 can be configured to delete near duplicates (classify as known bad errors) in the same way automatically, while others may need to be analyzed further to determine which is the correct record, and can be flagged for human input as described herein. Next, automated estimation tools can be configured to allow erroneous data to be replaced, or missing data to be completed, by “best guess” calculated values that essentially bridge over those records. A variety of preset standard algorithms are provided by the data quality system for this task, with each being optimized for the specific data type and situation. For example, an estimation algorithm for kilowatt-hour measurements will be different than the treatment for humidity or real-time pricing data. Or again, the data quality tool may be configured to flag the data anomaly for human input.

The EEM system 100 is configured to classify how the data should be corrected, and may incorporate exogenous factors, such as weather, to make those recommendations more feasible. A common and simple example of estimation is straight-line averaging. In this case, a bad data point for a particular energy interval reading is replaced with a value representing the straight-line average of the data point values on either side of it. This kind of point-to-point linear interpolation can be applied to multiple contiguous data points that are either missing or otherwise in error. Rules can be set defining the maximum time span allowable for interpolation to be applied. For example, if a time span of suspect data exceeds the allowable duration, estimation can be performed using data from other similar days. Typically, a number of selected reference days are chosen and their data averaged to produce the replacement data. Reference days need to closely represent the day whose data is being estimated, for example by being the same day of the week, weekend, or holiday as close as possible to the day in question. The data used for estimating would also need to be data that was originally valid; in other words, estimated data cannot be generated from already estimated data. In addition, days that experienced an unusual event, such as a power failure, could not be used for this purpose.

Finally, missing or corrupt data can be corrected either automatically, or through manual input or direct editing.

Accordingly the EM system 100 validates or corrects data anomalies that can be confidently classified by a data quality component 115 as correct or “Known Good” data (correctly reported true measurements of an unusual situation), and data anomalies that can be confidently classified by software as incorrect or “Known Bad” data (incorrectly measured or reported readings) are automatically corrected without human input using data validation systems as known in the art. Identified data anomalies that cannot with confidence be automatically classified as either “Known Good” or “Known Bad” constitute a third group (“Need Human Input”). The first two groups or types of data (i.e., Known Good and Known Bad) can be automatically classified and corrected or processed but the third group (i.e., Need Human Input) requires input from people with knowledge about the systems and equipment being monitored. Described are embodiments a system that streamlines handling of anomalies that fit into this third category and minimize the effort required from users. When the data quality component 115 detects an anomaly in the data streams it is monitoring that it cannot conclusively resolve without human input, the system will, in accordance with some embodiments, check configuration information to determine the following:

1. if there is a previously registered responsible person for that stream of data who can be reached with a valid correspondence medium and their contact information in that medium.

2. the responsible person's preferred language of correspondence

3. the resolution options for the detected condition that the responsible person needs to choose among.

The EEM system 100 is configured to compose a communication (e.g., by means of the data quality tools) to the responsible user with an explanation of the problem, possibly including graphical images needed to clarify the decision options if the medium supports them, and a series of embedded responses, similar to “mailto” or other hyperlinks, attached to each possible response. Each link, representing a choice, will initiate communication back to the database server 111 conveying the user's choice. That communication, depending on the link type, might be a response email whose subject and body will carry information about the specific episode of communication and the choice made. An alternate equivalent link type might initiate a parameterized HTTP GET request whose parameter communicated the user's choice. If the correspondence medium does not support embedded responses, the message may contain a web site URL address and login information where the choices can be viewed and responses selected.

Any computer accessible correspondence-like medium as known to ordinarily skilled artisans can be used for communication, for example with email, SMS (Short Message Service), Instant Messaging (IM), an automated voice message, or a post or other communication to social media platform 118. Social media platforms 118 include social media or social networking websites such as Facebook, Google+, MySpace, and FourSquare. Social media platforms 118 also include information networks or social information networks such as Twitter. Social media platforms 118, also called Web 2.0 websites, include those websites that facilitate to a greater extent participatory information sharing, interoperability, user-centered design, and collaboration than Web 1.0 websites. A simplified network architecture for a social media platform includes a server, a network, and a population of web-based social network members. The server can also comprise web-based social network databases, which can include a web-based database of any entity that provides web-based social networking services, communication services and/or social interaction services. An exemplary description of a social network is found in U.S. patent application Ser. No. 11/899,809 (published as U.S. Patent Publication No. 2009/0070168) entitled Enterprise Energy Management System with Social Network Approach to Data Analysis, the entirety of which is hereby incorporated by reference.

For a correspondence medium like email or a post on a social media platform 118 that supports embeddable links to initiate a response communication, the response can encode both the desired action and a serial number uniquely identifying the originating communication, which would be used by the system to retrieve information on the specific data correction episode. For correspondence medium like SMS or an automated voicemail message which do not support embeddable response links, the original communication could include login information encoding the uniquely identifying serial number which can be input at a response web site where the data problem details could be viewed and response choices could be selected. This uniquely identifying serial number would make it possible for the system 100 to keep track of multiple episodes of communication with various recipients at the same time.

In one embodiment, an example of choices that might be presented to a responsible party in a correspondence via email or post as follows.

Summary/title: “This looks like a data spike:” Included in the body of the email is a graph depicting the questionable data, with enough context data to facilitate informed decision making by the recipient. The recipient can also be presented with a series of choices, such as:
This data is normal, take no action. Continue to contact me with similar episodes.
This data is normal, take no action. Do the same without contacting me for similar episodes in the future.
Correct this data by distributing the spike over the previous gap. Continue to contact me with similar episodes.
Correct this data by distributing the spike over the previous gap. Do the same without contacting me for similar episodes in the future.
Correct this data by replacing it with data from the same time the previous day. Continue to contact me with similar episodes.
Correct this data by replacing it with data from the same time the previous day. Do the same without contacting me for similar episodes in the future.
Correct this data by replacing it with data from the same time the previous week. Continue to contact me with similar episodes.
Correct this data by replacing it with data from the same time the previous week. Do the same without contacting me for similar episodes in the future.
I need more information, have the system operator contact me
I am the wrong person to receive this email, have the system operator contact the correct person.

The system 100 can also be configured to allow entry of choices by other media known in the art, such as interactive voice response (IVR) systems or web-based software. When the user selects a resolution decision, the email can include an executable auto-response generation as known to ordinarily skilled artisans, which includes the serial number and the selected resolution for processing by the system, as described herein. Or, if the user has accessed the system, the user can enter the identification number and a selection choice, which are processed by the system.

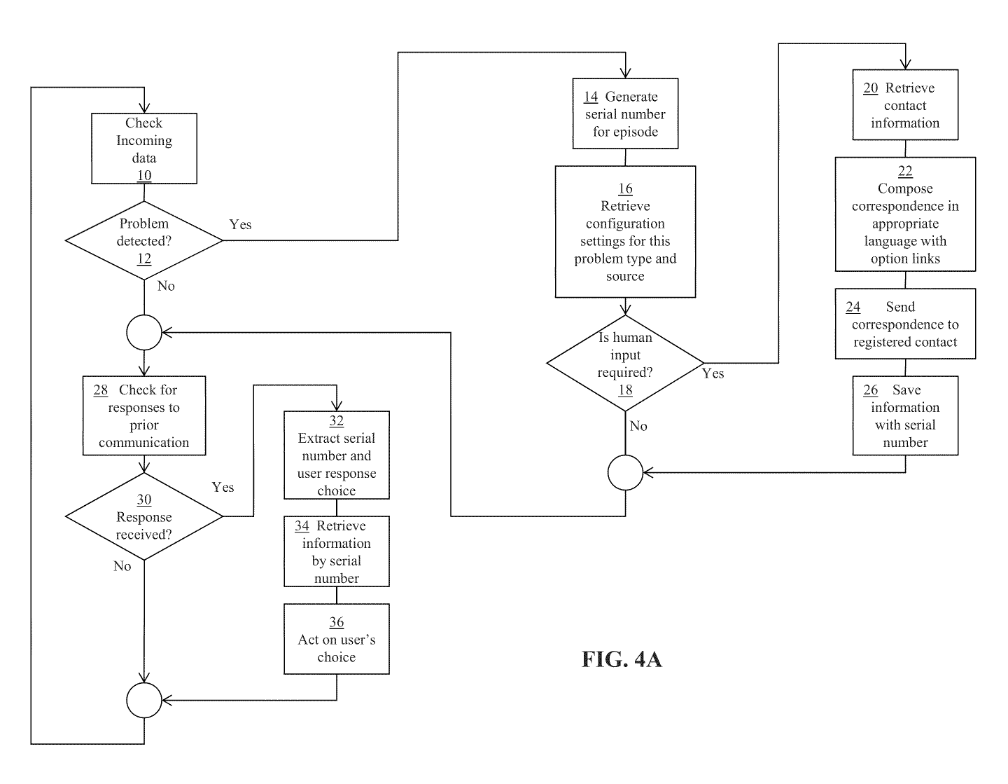

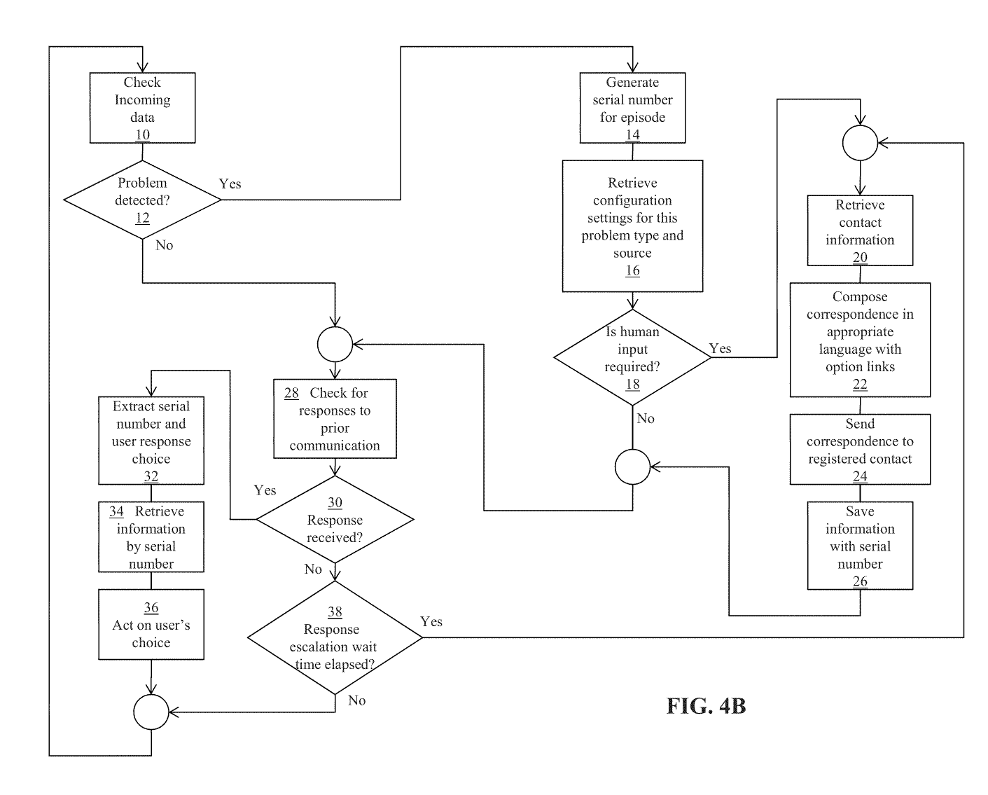

FIG. 4A illustrates exemplary high level processing of a method implemented by an EM system according to an illustrative embodiment. At block 10, the EM monitor of the data quality component 115 monitors one or more streams of incoming EM data from one or more EM data sources 105-110 for anomalous data conditions as determined in a configuration step by a system operator. At block 12, the data quality component 115 software checks for a data anomaly event in the EM data. If no anomaly is detected, the process continues to check for responses to prior communications (block 28), which will be further described below. (It will also be understood that while various operations, like checking incoming data and checking for responses to prior communications, may be shown and/or implemented as serially executed processes or threads, or the like, in some embodiments various such operations (e.g., where there is no strict conditioning or dependence of one operation based on the output of another) may be implemented concurrently or independently. As such, in FIG. 4A, when various operations are executed and the process flow is shown as rejoining or resuming with a subsequent process, that subsequent process may, in fact, be an independently executable process and the flow to that process may represent a logical flow for purposes of ease of description rather than a sequential and conditional flow.)

If, however, in block 12 a problem is detected, the system determines if a resolution for the data anomaly event requires human input; and if so submits a request via electronic correspondence to at least one user for human input to resolve the data anomaly event. For example, as shown in the illustrative flow, at block 14, the data quality component 115 generates identification for the data anomaly event, such as a serial number or other unique identifier like a Globally Unique Identifier (GUID). At block 16, the system retrieves the configuration settings for the type of data anomaly detected and the source of the problem, including, for example, information about previous assessments of similar anomalies for the same measurement and source, user communication preferences, required threshold of confidence before an anomaly is considered “Known Good” or “Known Bad”, and any other configuration items required to make an automated decision about whether to initiate a communication episode. At block 18 the system determines if human input is required. The system then takes this information and classifies the data anomaly into a diagnostic class for resolution to determine if human input is required to resolve the anomaly episode. The diagnostic class comprises a class selected from: Known Good, Known Bad, and Need Human Input as described herein.

If human input is needed, at block 20 the system retrieves contact information for one or more users from a contact database, for example, of registered or authorized users of the EM system, and particularly those associated with the physical location at which the anomalous data was recorded. At block 22, the system then generates a request including data anomaly episode information for the at least one user as described herein. The request can include data anomaly event information, including a description of the anomaly and a plurality of resolution decisions, as described above. As also noted above, the request can be generated in the appropriate language for that user and can include option links or links to a website to select data anomaly resolution options as described herein. At block 24 the correspondence is submitted to the contact via known electronic media as described herein (e.g., an SMS message, voicemail, instant messaging, and a posting to social media platform.). At block 26, a record of the request including the identification number (e.g. the serial number) is saved or recorded in storage database for a resolution response from the contact. In some embodiments, the EM system provides for certain users or operators of the EM system to access (e.g., view) information (not shown) concerning such stored records, allowing them to know, for example, the fact that a communication has been sent, when it was sent, etc. Also, in some embodiments, the EM system may automatically notify (not shown) certain users or operators (e.g., who registered to receive notifications concerning certain facilities or anomalies or the like) of the communication. This correspondence generation and sending related process then closes, and the system continues checking for responses to prior communications (block 28).

At block 28, the data quality component 115 software checks, either by periodic polling or via continuous monitoring, to determine if a resolution response message for an outstanding request has been received. At block 30, if a resolution response has not been received, the system continues checking for incoming data (block 10). If a response message has been received, the response is associated with the identification in the storage database, and a resolution response from the resolution response message is identified. For example, at block 32 the identification number or serial number and the user's response choice are extracted from the response message. Then, at block 34, based on the extracted identification or serial number, the system retrieves information (e.g., the record) stored in the database (at block 26). At block 36, the system resolves the data anomaly episode in accordance with the resolution response, i.e., by acting on the user's response choice. As can be appreciated, the system can be configured to send and receive messages to one user or, in the alternative, to simultaneously send messages to a plurality of users in order to resolve a potential data anomaly.

In some embodiments, as shown at FIG. 4B the method can further comprise an escalation routine; if it is determined that a resolution response message for an outstanding request has not been received, the EM system generates a subsequent correspondence request to at least one alternative user for human input. For example, in one embodiment, if at block 30 the system determines a resolution response message for an outstanding request has not been received, at block 38 the system determines if a predetermined time period has passed. If not, the system continues checking incoming data (block 10); however, if a predetermined time has passed, the system moves to generate and submit a subsequent request to one or more other users for human input via the same processes (i.e., as shown at blocks 20-26). For example, supervisors, managers, social network users, or other site users could be contacted. The system then also checks for responses these subsequent requests (in block 28).

In another embodiment, the method can comprise retrieving contact information for a plurality of users from a contact database; generating the correspondence request for the plurality of users; submitting the request to the plurality of users for human input to resolve the data anomaly event. Accordingly, if adequate responses have not been received within a predetermined amount of time, correspondence requests can be escalated to other peer or management users, or request can be sent to multiple users in order to resolve one anomaly (different questions for different roles, aggregate responses), etc.

In another embodiment, EM data can include acquired EM attribute data and presenting it to a user to help resolve a data anomaly as part of a ‘decision package’. Examples of associated EM attribute data comprise that identified above, including coincident equipment status information, maintenance management system data, building calendar of events, weather data, as well as data provided via, for example, web services as described herein, and so on. Also included in the EM attribute data can be a history of data anomaly resolution, including users responses as described herein, that have a common attribute (e.g., a history of data anomaly resolution at the same site). EM attribute data can be (a) structured and machine-readable; or (b) unstructured but can be acquired and presented to a user for resolution.

In another embodiment, the EM software 101 can configured to process learnings to enable and refine automation of the resolution of data anomaly events. For example, the system can be configured to record the EM resolution information (e.g., from the resolution response message from the users) and associates the resolution response with a diagnostic class that does not require human input. For instance, once a user decides what action to take, the data quality component 115 software can be directed to automatically take the same response in the future if the same anomaly and/or associated events (e.g., as indicated by attribute data) occurs in the future. Future similar episodes can be pushed or reclassified out of a ‘Need Human Input’ category into the ‘Known Good’ or ‘Known Bad’ category, reducing the need for future communication. For example, if a building calendar were available and indicated a scheduled disruption for electrical maintenance, that information would help to classify an interruption of energy data for the same period.

In another embodiment, the system is configured to resolve a data anomaly by presenting EM attribute data related to or associated with the data anomaly episode. For example, the method can comprises: receiving energy management (EM) data from a plurality of energy data sources; detecting a plurality of data anomaly events in the EM data; and analyzing the data from the plurality of energy data sources to determine if the data anomaly events meet at least one correlation criterion. For example, an EEM monitoring service 120 can be configured with a “data anomaly aggregation service” that receives EM data about potential anomalies from multiple users and sites as described in FIG. 1B and correlates these anomalies with other EM related data acquired by the service.

For instance, several users at several buildings or monitoring multiple IEDS 140-144, in the same geographic area or local site (e.g., Site 1) subscribe to the service, which correlates data quality problems detected in buildings with geographically localized problems like communication network disruption. The system 120 identifies data failures detected at multiple buildings or a related production line via IED's 142-144 at the same time in the same area Site 1, indicating that the failures may be related. Thus if EM data anomaly event such as a network disruption meets a number of correlation criteria such as (1) same anomaly (network failure) (2) same site (Site 1) and (3) multiple loads or buildings 140-144 then the data can be further processed for resolution action. For example, upon meeting a correlation criterion, the package of EM data can be presented to the appropriate users for resolution (e.g. the EEM monitoring service 120 may obtain data showing the same data anomaly for IEDs 144, receiving energy from an electric utility 146 in Site 1).

In another embodiment, the actions taken by users may be aggregated and presented to others. For example: upon viewing the service suggestion that a data dropout is related to a power interruption, the user also sees that 80% of users accepted this suggestion. The system can be configured to aggregate the energy management (EM) data from the plurality of energy data and presents the data anomaly events to a plurality of users for a resolution decision. In one embodiment, the system is configured to allow the users to see the resolution decisions of other users on a display medium selected from a: website, via interconnected software; or on a social media platform 118. For example, the system can display the information via a social media platform, for instance as described in U.S. patent application Ser. No. 11/899,809 (published as U.S. Patent Publication No. 2009/0070168) entitled Enterprise Energy Management System with Social Network Approach to Data Analysis, the entirety of which is hereby incorporated by reference.

While the invention has been described and illustrated with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments or otherwise understood in view of the disclosure and/or that may be realized in some embodiments thereof.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A method implemented by at least one computer upon executing programming code stored on at least one non-transitory computer-readable medium, the method comprising:
monitoring energy management (EM) data from at least one energy data source;
detecting a data anomaly event in the EM data;
determining if a resolution for the data anomaly event requires human input; and
submitting an automated request to at least one user for human input to resolve the data anomaly event; and
recording a record of the request in a database for a resolution response from the at least one user.

2. The method of claim 1, further comprising:
generating an identification for the data anomaly event;
retrieving contact information for at least one user from a contact database;
generating the request including data anomaly event information for the at least one user; and
recording the contact information and the identification in a database for a resolution response from the at least one user.

3. The method of claim 1, further comprising:
generating the request including data anomaly event information, wherein the data anomaly information includes a plurality of resolution decisions.

4. The method of claim 3, where in the request is configured to automatically generate a response that includes the user's resolution decision selected from the plurality of resolution decisions and an identification for the data anomaly event.

5. The method of claim 1, further comprising:
classifying the data anomaly into a diagnostic class for resolution.

6. The method of claim 5, wherein the diagnostic class comprises a class selected from:
Known Good, Known Bad, and Need Human Input.

7. The method of claim 1, further comprising:
determining if a resolution response message for an outstanding request has been received.

8. The method of claim 7, further comprising:
if resolution response message has been received, associating the response with the identification in the database;
identifying a resolution response from the resolution response message; and
resolving the data anomaly event in accord with the resolution response.

9. The method of claim 7 wherein the method further comprises:
if it is determined that a resolution response message for an outstanding request has not been received, generating a subsequent correspondence request to at least one other user for human input.

10. The method of claim 2 wherein the method further comprises:
retrieving contact information for a plurality of users from a contact database;
generating the correspondence request for the plurality of users;
submitting the request to the plurality of users for human input to resolve the data anomaly event.

11. The method of claim 1 wherein the method further comprises:
submitting the at least one request to at least one user via a correspondence medium selected from the group of: email, an SMS message, voicemail, instant messaging, and a posting to social media platform.

12. The method of claim 1 wherein the method further comprises:
acquiring associated EM attribute data related to the data anomaly event; and
submitting the at least one data anomaly event and the EM attribute data to the at least one user.

13. The method of claim 12 wherein associated EM attribute data is selected from the group including:
coincident equipment status information, maintenance management system data, a calendar of events, weather, financial information data, news data, and a history of data anomaly resolutions for a energy source.

14. The method of claim 12 wherein the method further comprises:
recording the resolution information in the resolution response message; and
associating the resolution response with a diagnostic class that does not require human input.

15. The method of claim 1 wherein the method further comprises:
receiving the EM data from a plurality of energy data sources;
detecting a plurality of data anomaly events in the EM data; and
analyzing the data from the plurality of energy data sources to determine if the data anomaly events meet at least one correlation criterion.

16. The method of claim 15 wherein the method further comprises:
aggregating the EM data from the plurality of energy data sources;
presenting at least one of the EM anomaly data events to a plurality of users for a resolution decision.

17. The method of claim 16 wherein the method further comprises:
allowing the users to see the resolution decisions of other users.

18. The method of claim 15 wherein the method further comprises:
allowing the users to see the resolution decisions of other users on a display medium selected from: a website, via interconnected software; a data feed, or on a social media platform.

19. A method implemented by at least one computer upon executing programming code stored on at least one non-transitory computer-readable medium comprising:
monitoring energy management (EM) data from a plurality of energy data sources;
detecting a plurality of data anomaly events in the EM data;
analyzing the data from the plurality of energy data sources to determine if the data anomaly events meet at least one correlation criterion; and
if the data anomaly events meet the correlation criterion, processing the data in accord with the correlation criterion to resolve the data anomaly events.

20. The method of claim 19 wherein the method further comprises:
aggregating the EM data from the plurality of energy data sources;
presenting at least one of the EM anomaly data events to a plurality of users for a resolution decision.

21. The method of claim 20 wherein the method further comprises:
allowing the users to see the resolution decisions of other users.

22. The method of claim 21 wherein the method further comprises:
allowing the users to see the resolution decisions of other users on a display medium selected from: a website, via interconnected software; a data feed, or on a social media platform.

23. A method comprising:
monitoring energy management (EM) data from an energy data source;
detecting at least one data anomaly event in the EM data;
acquiring associated EM attribute data related to the data anomaly event; and
presenting the at least one data anomaly event and the EM attribute data to a user.

24. The method of claim 23 wherein associated EM attribute data includes:
coincident equipment status information, maintenance management system data, a calendar of events, a history of data anomaly resolution for a energy source.

25. The method of claim 23 wherein the method further comprises:
receiving resolution information from a user's resolution response; and
associating the resolution information with a diagnostic class that does not require human input.

26. An EM system for power management, the system comprising at least one computer, at least one storage device in which is stored EM data, and at least one non-transitory computer readable medium storing thereon computer code which when executed by the at least one computer causes the at least one computer to at least:
monitor energy management (EM) data from at least one energy data source;
detect a data anomaly event in the EM data;
determine if a resolution for the data anomaly event requires human input; and
submit an automated request to at least one user for human input to resolve the data anomaly event; and
record a record of the request in a database for a resolution response from the at least one user.

27. At least one non-transitory computer-readable medium that stores programming code that when executed by at least one computer, instructs the at least one computer to execute a method comprising:
monitoring energy management (EM) data from at least one energy data source;
detecting a data anomaly event in the EM data;
determining if a resolution for the data anomaly event requires human input; and
submitting an automated request to at least one user for human input to resolve the data anomaly event; and
recording a record of the request in a database for a resolution response from the at least one user.

28. An EM system for power management, the system comprising at least one computer, at least one storage device in which is stored EM data, and at least one non-transitory computer readable medium storing thereon computer code which when executed by the at least one computer causes the at least one computer to at least:
monitor energy management (EM) data from a plurality of energy data sources;
detect a plurality of data anomaly events in the EM data;
analyze the data from the plurality of energy data sources to determine if the data anomaly events meet at least one correlation criterion; and
if the data anomaly events meet the correlation criterion, processing the data in accord with the correlation criterion to resolve the data anomaly events.

29. At least one non-transitory computer-readable medium that stores programming code that when executed by at least one computer, instructs the at least one computer to execute a method comprising:
monitoring energy management (EM) data from a plurality of energy data sources;
detecting a plurality of data anomaly events in the EM data;
analyzing the data from the plurality of energy data sources to determine if the data anomaly events meet at least one correlation criterion; and
if the data anomaly events meet the correlation criterion, processing the data in accord with the correlation criterion to resolve the data anomaly events.
